(19) United States
(12) Patent Application Publication
(10) Pub. No.: US 2022/0221131 A1
(43) Pub. Date: Jul. 14, 2022

(54) FLOOR LAMP WITH FLOATING LIGHT REFLECTING MEMBER

(71) Applicant: Ted Shapiro, New York, NY (US)

(72) Inventor: Ted Shapiro, New York, NY (US)

(21) Appl. No.: 17/610,213

(22) PCT Filed: May 12, 2020
(86) PCT No.: PCT/US2020/032441

§ 371 Date: Nov. 10, 2021

Related U.S. Application Data
(60) Provisional application No. 62/847,896, filed on May 14, 2019.

(51) Int. Cl. F21V 14/04; F21S 6/00

(52) U.S. Cl. CPC F21V 14/04; F21S 6/004

(57) ABSTRACT

A floor lamp includes a base, a light-permeable pipe extending upwardly from the base, a light reflecting member movably disposed in the light-permeable pipe, a light source disposed in the base for emitting light toward the light reflecting member, and an air blower disposed in the base for blowing air toward the light reflecting member to float the light reflecting member in the air inside the light-permeable pipe. As a result, the light reflected from the light reflecting member is floating in the air and visible via the light-permeable pipe. The floor lamp of the present invention may additionally include an ambient light located on the top of the light-permeable pipe, so that the floor lamp provides not only the above-described magic floating light for decoration, but also the ambient light for illumination.

### BACKGROUND OF THE INVENTION

### 1. Field of the Invention

The present invention relates generally to lamps and more particularly, to a floor lamp with a floating light reflecting member.

### 2. Description of the Related Art

The conventional floor lamps usually have a vertical standing structure and one or more lights fixed on the top and/or the section near the top of the vertical standing structure. Such lamps are monotonous in function and light-emitting effect thereof.

### SUMMARY OF THE INVENTION

Therefore, it is an objective of the present invention to provide a floor lamp with a floating light reflecting member, wherein the position of the light is changeable between the top and the bottom of the floor lamp.

To attain the above objective, the present invention provides a floor lamp which includes a base, a light-permeable pipe extending upwardly from the base, a light reflecting member movably disposed in the light-permeable pipe, a light source disposed in the base for emitting light toward the light reflecting member, and an air blower disposed in the base for blowing air toward the light reflecting member to float the light reflecting member in the light-permeable pipe.

As a result, the light source can emit light to the light reflecting member to cause the light reflecting member to glow and be visible through the light-permeable pipe, and the air blower can cause the light reflecting member to floatingly move upwardly or downwardly in the light-permeable pipe by increasing or decreasing an air flow rate or cause the light reflecting member to stay at any position (height) in the light-permeable pipe by keeping a constant air flow rate. Therefore, the light reflected from the light reflecting member is movably and visibly floating in the air between the top and the bottom of the light-permeable pipe and the light reflecting member appears to be lit without any attached wires.

The floor lamp of the present invention may additionally include an ambient light located on the top of the light-permeable pipe, so that the floor lamp provides not only the above-described magic floating light for decoration, but also the ambient light for illumination.

Further scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is an assembled perspective view of a floor lamp according to a preferred embodiment of the present invention;

FIG. 2 is an assembled perspective view of a bottom part of the floor lamp in a condition that a covering pipe, a covering plate and a light-permeable pipe are removed;

FIG. 3 is an exploded perspective view of the structure shown in FIG. 2;

FIG. 4 is an assembled perspective view of a part of the structure shown in FIG. 3;

FIG. 5 is an exploded perspective view of the structure shown in FIG. 4;

FIG. 6 is an exploded perspective view of a top part of the floor lamp;

FIG. 7 is an assembled perspective view of a part of the structure shown in FIG. 6;

FIG. 8A is a sectional view of the structure shown in FIG. 6 and a light reflecting member, showing the widest part of the light reflecting member floats above a retaining plate;

FIG. 8B is a schematically enlarged view of a part of FIG. 8A;

FIG. 9 is similar to FIG. 8B, but showing the light reflecting member is retained at the top of the light-permeable pipe;

FIG. 10 is similar to FIG. 1, but showing the light reflecting member floating in the light-permeable pipe; and

FIG. 11 is another assembled perspective view of the floor lamp.

### DETAILED DESCRIPTION OF THE INVENTION

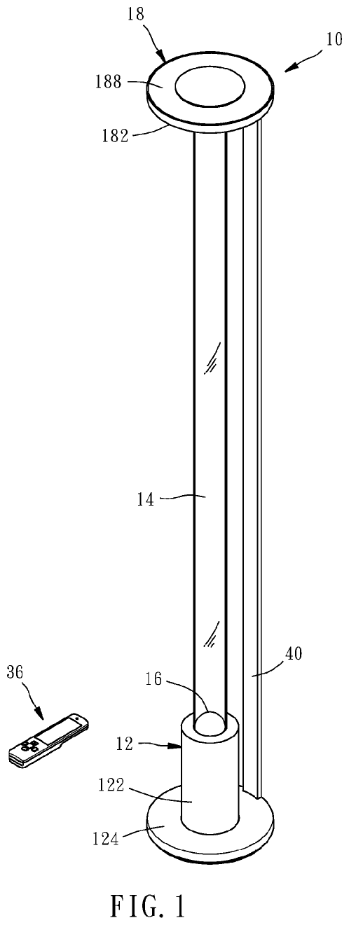

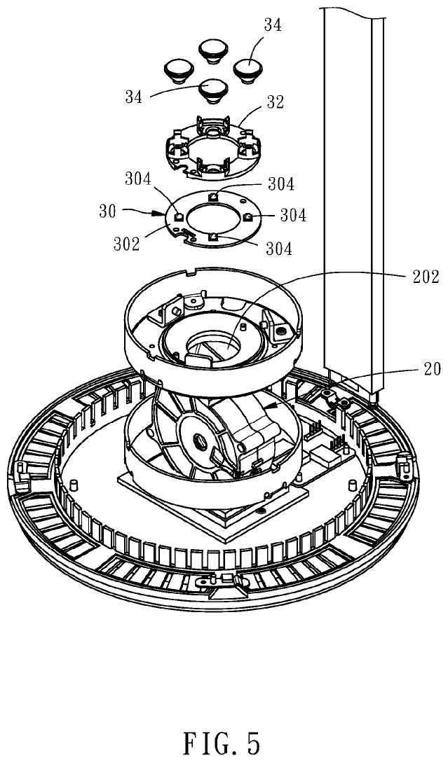

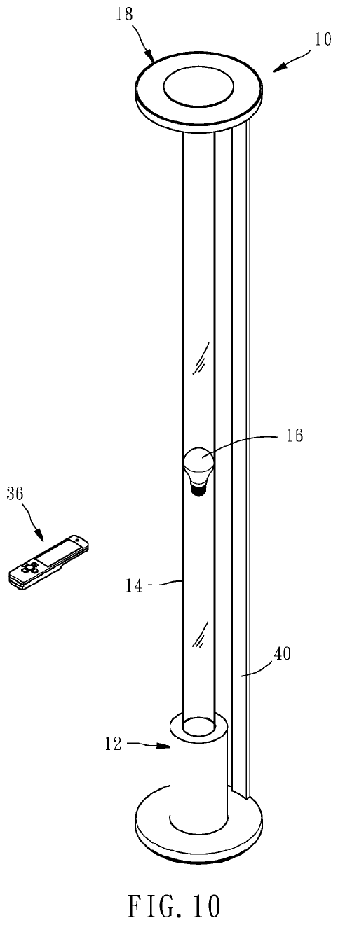

Referring to FIG. 1, a floor lamp 10 according to a preferred embodiment of the present invention includes a base 12, a light-permeable pipe 14 made of translucent or transparent glass or plastics and extending upwardly from the base 12, a light reflecting member 16 movably disposed in the light-permeable pipe 14, and a retaining device 18 disposed on the top end of the light-permeable pipe 14. Referring to FIG. 10, the light reflecting member 16 is shaped as a bulb, but it is actually a non-electronic component having a metal screw base and a plastic translucent or transparent dome-shaped body. The shape of the light reflecting member 16 is unlimited, which may be a sphere or any other shape which has a shape profile conducive to floating in a column of air. The light reflecting member 16 is configured to be lighted up by receiving and reflecting light emitted from a light source 30 contained within the base 12 as shown in FIG. 5, which will be detailed described below. Besides, the floor lamp 10 includes a hollow connecting pole 40 connecting the base 12 and the retaining device 18. The electric wires (not shown) of the floor lamp 10 extends from the base 12 to the retaining device 18 through the connecting pole 40.

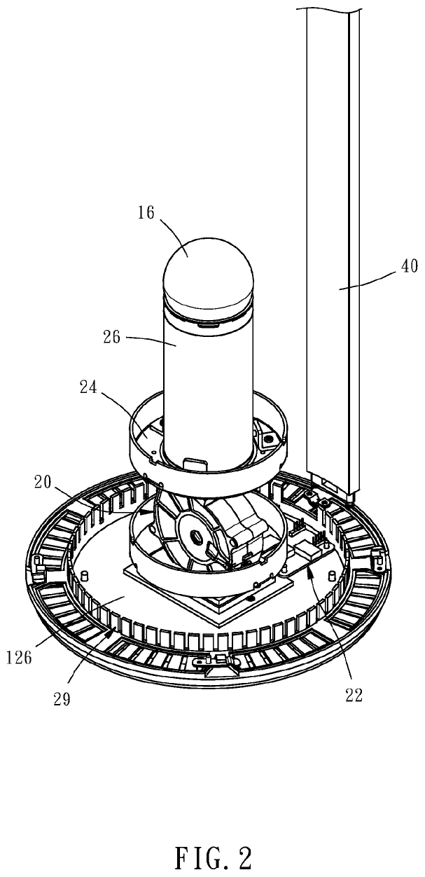

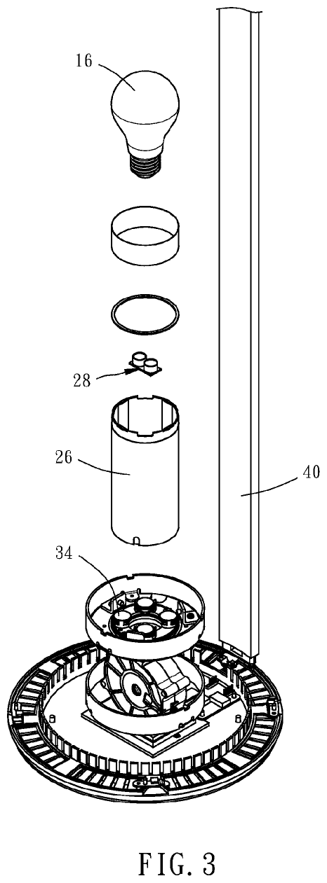

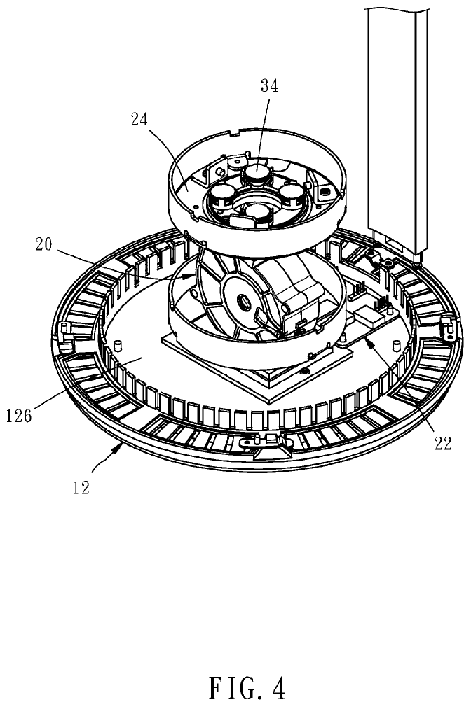

The floor lamp 10 further includes other members located in a covering pipe 122 and a covering plate 124 of the base 12. Referring to FIGS. 2-3, the floor lamp 10 includes an air blower 20 fixedly disposed on a bottom plate 126 of the base 12, a control device 22 fixedly disposed on the bottom plate 126 of the base 12, an annular supporting plate 24 fixedly disposed on the top of the air blower 20, a light channel device 26 disposed on the annular supporting plate 24, a position sensor 28 disposed in the light channel device 26, and a dust filter 29 surrounding the air blower 20 for preventing dust from entering the central region of the base 12. The light channel device 26 is disposed in a bottom section of the light-permeable pipe 14 located in the covering pipe 122 of the base 12. The light reflecting member 16 is located above the light channel device 26 and the position sensor 28. Referring to FIGS. 4-5, at the bottom of the light channel device 26, the floor lamp 10 further includes a light source 30 disposed on the annular supporting plate 24, a lens bracket 32 disposed on the light source 30, and four lens 34 disposed on the lens bracket 32.

The air blower 20 is arranged to blow air toward the light reflecting member 16 through the light channel device 26 to cause the light reflecting member 16 to float in the light-permeable pipe 14, as shown in FIG. 10. Specifically, the outer diameter of the dome-shaped body is slightly smaller than the inner diameter of the light-permeable pipe 14 and light enough to be floatingly lifted up by an air flow. As such, the ambient air in the base 12 will be sucked into the air blower 20 and blown toward the light reflecting member 16 to float the light reflecting member 16 and then escape out of the light-permeable pipe 14 via the retaining device 18. When the air flow rate of the air blower 20 increases, the light reflecting member 16 moves upwardly in the light-permeable pipe 14. When the air flow rate of the air blower 20 decreases, the light reflecting member 16 moves downwardly in the light-permeable pipe 14. When the air flow rate of the air blower 20 is kept at a constant value, the light reflecting member 16 stationarily floats in the light-permeable pipe 14 at a specific height.

The position sensor 28 is an ultrasonic sensor module including an emitter and a receiver for sensing the position (height) of the light reflecting member 16. The control device 22 is a printed circuit board assembly, on which electronic components, such as a microcontroller unit (MCU), Bluetooth module, a pulse width modulation (PWM) IC are mounted, for controlling the air flow rate of the air blower 20 according to the position of the light reflecting member 16 detected by the position sensor. For example, the user uses a remote control 36 having a display screen (as shown in FIG. 1), in which a Bluetooth module and a G-sensor are built, to turn on the floor lamp 10 via Bluetooth technology. By means of changing the posture of the remote control 36 to incline upward or downward, the posture of the remote control 36 is sensed by the G-sensor and then a wireless signal responsive to the posture of the remote control 36 will be transmitted to the control device 22 to command the air blow 20 to increase or decrease the air flow rate so as to blow the light reflecting member 16 to move in the light-permeable pipe 14 upward or downward. With this technical feature, the light reflecting member 16 may be floatingly positioned at any desired height level or dynamically moved in the light-permeable pipe 14 by regulating the air flow rate generated by the air blow 20 according to a real-time detection of the height of the light reflecting member 16 contributed by the position sensor 28.

As shown in FIG. 5, the light source 30 includes an annular circuit board 302 surrounding the air outlet 202 of the air blower 20, and RGBW (red, green, blue and white) LEDs 304 disposed on the annular circuit board 302, so that the light source 30 can emit light with any color toward the light reflecting member 16 to light up the light reflecting member 16 with any light color. In other words, the user can use the remote control 36 to change the light color of the reflecting light of the light reflecting member 16. The four lenses 34 are located above the RGBW (red, green, blue and white) LEDs 304 respectively for focusing the lights of the LEDs 304, and the light channel device 26 serves to guide light emitted from the LEDs 304 to stream, with minimal outward light spill, along the axial direction of the light-permeable pipe 14 to then being reflected by the light reflecting member 16, such that the light reflecting member 16 will be shining like a light source and visible via the light-permeable pipe 14.

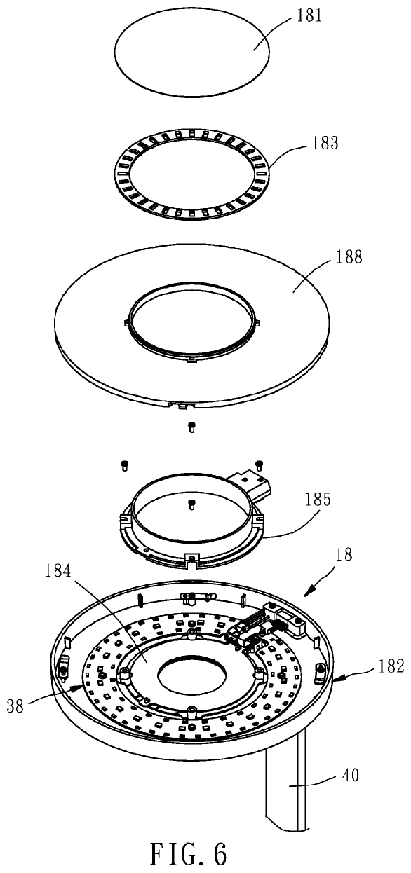

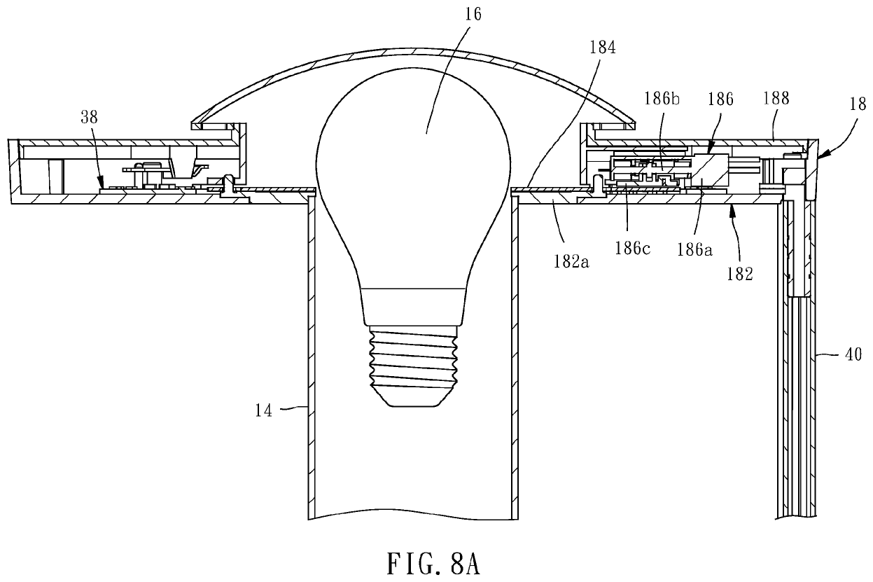

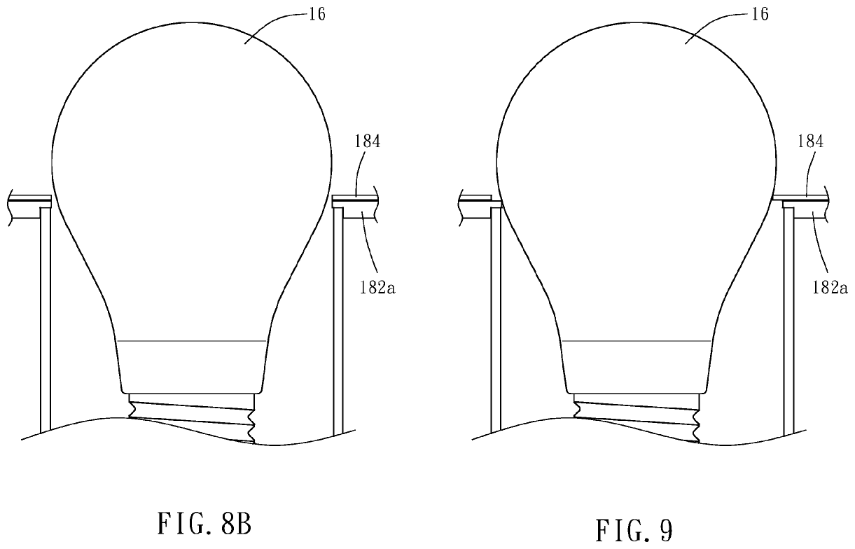

Referring to FIGS. 6-9, the retaining device 18 primarily includes a fixed seat 182 fixedly disposed on the top end of the light-permeable pipe 14, a transparent retaining plate 184 moveably disposed in the fixed seat 182, and a driving unit 186 disposed in the fixed seat 182 for driving the retaining plate 184 to move relative to the fixed seat 182. The fixed seat 182 is provided on the bottom thereof with a transparent window 182a which has a first opening 182b communicating with the light-permeable pipe 14. The diameter of the first opening 182b is equal to the inner diameter of the light-permeable pipe 14. The retaining plate 184 has a second opening 184a communicating with the first opening 182b and the light-permeable pipe 14. The diameter of the second opening 184a is equal to the diameter of the first opening 182b. The driving unit 186 includes a motor 186a, a threaded shaft 186b connected with the motor 186a and drivable by the motor 186a to rotate, and a linear moving seat 186c screwingly sleeved onto the shaft 186b, such that the linear moving seat 186c can move along the threaded shaft 186b back and forth when the threaded shaft 186b is driven by the motor 186a to rotate. The linear moving seat 186c has an end fixed to the retaining plate 184 for driving the retaining plate 184 to move linearly. In the normal condition, as shown in FIGS. 8A and 8B, the first and second openings 182b and 184a are concentric with each other and with the opening on the top of the light-permeable pipe 14. In such condition, when the light reflecting member 16 is moved to the top end of the light-permeable pipe 14, the light reflecting member 16 can freely continue to move upward through the first and second openings 182b and 184a. Because of the increased escape of air all around the light reflecting member 16 when it reaches the top edge of the opening 184a in the retaining plate 184, the light reflecting member 16 will float freely inside the opening 184a with the widest diameter of the light reflecting member 16 forced by the escaping air to float above the level of the top edge of the opening 184a in the retaining plate 184, as shown in FIGS. 8A and 8B. If the user wants the light reflecting member 16 to stay at the top end of the light-permeable pipe 14, the user can control the driving unit 186 via the remote control 36 to move the retaining plate 184 horizontally, such that the first and second openings 182b and 184a become eccentric with each other and thus too small for the full diameter of light reflecting member 16 to pass downward through them, as shown in FIG. 9. In such condition, a part of the inner edge of the retaining plate 184 pushes against the light reflecting member 16 and effectively narrows the hole of the combination of the first and second openings 182b and 184a, thereby retaining the light reflecting member 16. The other part of the inner edge of the retaining plate 184 moves away from the light reflecting member 16 but does not move past the outer diameter of the pipe 14, so that the inner edge cannot be seen from below. Note also that the light reflecting member 16 actually shifts very slightly to the side in position during this retaining function. After that, the air blower 20 and the light source 30 can be turned off by the user or will be automatically turned off according to the logic program in the MCU for saving energy, and the light reflecting member 16 will be still retained at the top end of the light-permeable pipe 14. Because the retaining plate 184 and the transparent window 182a are both transparent, and because the first and second openings 182b and 184a are colinear with the top edge of the light-permeable pipe 14, the horizontal movement of the retaining plate 184 cannot be easily detected by the casual observer. This allows the transition from the light reflecting member 16 floating at the top end of the light-permeable pipe 14 with the air blower 20 turned on to the light reflecting member 16 being retained at the top of the light-permeable pipe 14 with the air blower 20 turned off to be virtually undetected by the casual observer.

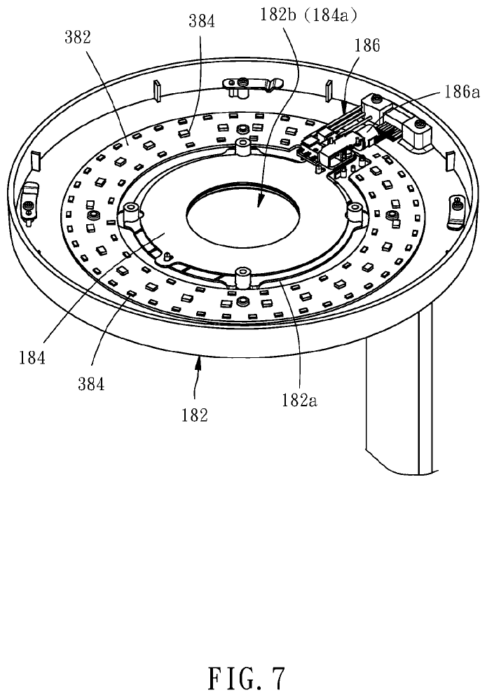

As shown in FIGS. 6-7, the floor lamp 10 includes another light source 38 disposed in the fixed seat 182 of the retaining device 18, so that the retaining device 18 also serves as an ambient light. The light source 38 includes an annular circuit board 382 surrounding the top end of the light-permeable pipe 14 and the first and second openings 182b and 184a, and a plurality of LEDs 384 comprised of both RGB (red, green, blue) LEDs and white-only LEDs disposed on the annular circuit board 382. Therefore, the floor lamp 10 can provide ambient illumination by the white-only LEDs 384 and also emits light of various colors by the RGB LEDs 384 through a transparent top cover 188 of the retaining device 18.

As shown in FIG. 6, the retaining device 18 further includes a top transparent dome 181, an air exhaust ring 183 and a light guard 185. When the air exits the light-permeable pipe 14, it goes up and out of the air exhaust ring 183. Because the transparent dome 181 covers the air exhaust ring 183, and the air exhaust holes are located under the transparent dome 181, this keeps dust from entering the unit at the top. And because of this design, the exhaust of air and noise from this is on top of the unit and not as obvious to the user. The light guard 185 prevents the LEDs 384 from leaking light toward the center and illuminating the light reflecting member 16 when the light reflecting member 16 is at the top. The light guard 185 also acts as the support for the mounting of the air exhaust ring 183 and the top transparent dome 181.

In addition to the user being able to selectively and individually control various functions of the floor lamp 10 using the remote control 36 as described above, the user can also use the remote control 36 to select from a variety of automatically running preset routines in the logic program in the MCU that don't require the user's intervention. These would include routines where the light reflecting member 16 moves at varying speeds to various positions in the light-permeable pipe 14 and holds these positions for various amounts of time. And these movements of the light reflecting member 16 would occur simultaneously with varying changes of color and brightness of both the light source 30 in the base 12 and the light source 38 in the retaining device 18. Another type of preset routine would involve a series of various functions that are run in a specific sequence. An example of such a routine might occur when the user turns on the lamp. The light source 30 in the base 12 would first turn on at a low level and then increase in brightness until the light reflecting member 16, lit by the light source 30, reaches full illumination. Then the air blower 20 would turn on and float the glowing light reflecting member 16 upwards through the light-permeable pipe 14. As the light reflecting member 16 begins to approach the top of the light-permeable pipe 14 then the light source 38 disposed inside the fixed seat 182 would begin to increase in brightness to create the effect that the light reflecting member 16 is “lighting” the ambient light source 38. Then when the light reflecting member 16 reaches the very top of the light-permeable pipe 14, and the light source 38 has now reached full brightness, the motor 186 moves the retaining plate 184 horizontally and as such retains the light reflecting member 16 before the air blower 20 is then shut off.

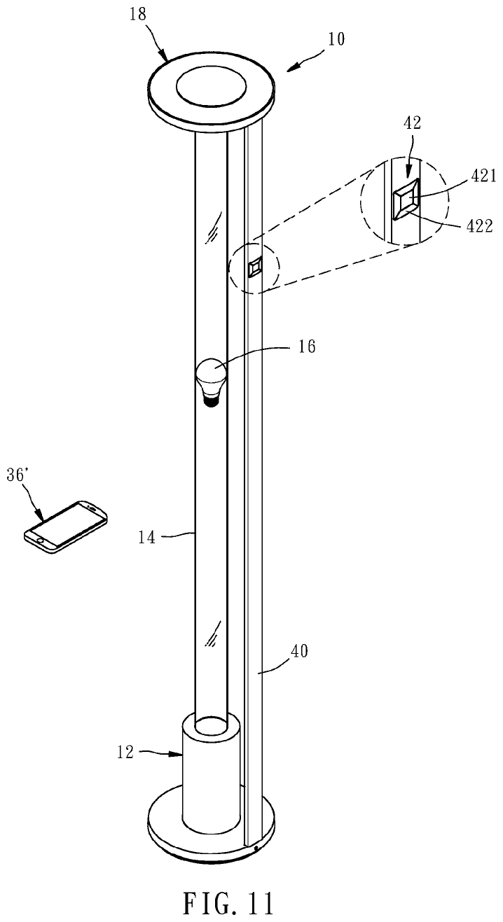

In addition to the remote control 36, a switch panel 42 as shown in FIG. 11 is also provided for control of the floor lamp 10. The switch panel 42 is disposed on the back of the connecting pole 40. The switch panel 42 includes a center button 421 for master on, off and brightness, and four outer buttons 422 for running saved preset routines. Through the switch panel 42, the floor lamp 10 can be operated for very basic functions without the remote control 36.

In addition to the remote control 36 and switch panel 42, a mobile app capable of running on all major mobile operating systems and stored in a mobile device 36′, such as smart phone, tablet, etc., as shown in FIG. 11 might also be provided for control of the floor lamp 10. Since most all mobile devices have built in Bluetooth modules and G-sensor technology, a mobile device running the app would be able to include all functionality of the remote control 36, but might also include additional features which the full operating system and connectivity of a mobile device can provide. These might include, but not be limited to, the ability for the user to create, save and run custom routines for the floor lamp 10, or create and save custom color change collections, and for the user to be able the share or download such routines and collections from the Internet.

What is claimed is:

1. A floor lamp comprising:
a base;
a light-permeable pipe extending upwardly from the base;
a light reflecting member movably disposed in the light-permeable pipe;
a light source disposed in the base for emitting light toward the light reflecting member; and
an air blower disposed in the base for blowing air toward the light reflecting member to float the light reflecting member.

2. The floor lamp as claimed in claim 1, wherein the floor lamp comprises a position sensor disposed in the base for sensing a position of the light reflecting member, and a control device disposed in the base for controlling an air flow rate of the air blower according to the position of the light reflecting member.

3. The floor lamp as claimed in claim 2, wherein the position sensor is an ultrasonic sensor module.

4. The floor lamp as claimed in claim 1, wherein the floor lamp comprises at least one lens located above the light source for focusing the light of the light source.

5. The floor lamp as claimed in claim 4, wherein the light source comprises at least one LED, above which the at least one lens is located.

6. The floor lamp as claimed in claim 1, wherein the floor lamp comprises a light channel device disposed in a bottom section of the light-permeable pipe; the light source is located at a bottom of the light channel device; the light reflecting member is located above the light channel device.

7. The floor lamp as claimed in claim 6, wherein the floor lamp comprises a position sensor disposed in the light channel device and located above the light source for sensing a position of the light reflecting member, and a control device disposed in the base for controlling an air flow rate of the air blower according to the position of the light reflecting member.

8. The floor lamp as claimed in claim 7, wherein the position sensor is an ultrasonic sensor module.

9. The floor lamp as claimed in claim 6, wherein the floor lamp comprises at least one lens located at the bottom of the light channel device and above the light source for focusing the light of the light source.

10. The floor lamp as claimed in claim 9, wherein the light source comprises at least one LED, above which the at least one lens is located.

11. The floor lamp as claimed in claim 1, wherein the floor lamp comprises a retaining device disposed on a top end of the light-permeable pipe for retaining the light reflecting member at the top end of the light-permeable pipe.

12. The floor lamp as claimed in claim 11, wherein the retaining device comprises a fixed seat provided on a bottom thereof with a first opening communicating with the light-permeable pipe and a retaining plate disposed in the fixed seat and having a second opening communicating with the first opening and the light-permeable pipe so that when the light reflecting member is located at the top end of the light-permeable pipe, the light reflecting member is inserted into the first opening and the second opening; the retaining plate is movable relative to the fixed seat for retaining and releasing the light reflecting member located at the top end of the light-permeable pipe.

13. The floor lamp as claimed in claim 12, wherein the retaining plate is transparent.

14. The floor lamp as claimed in claim 11, wherein the floor lamp comprises another light source disposed in the retaining device for emitting light toward a top surface of the retaining device.

15. The floor lamp as claimed in claim 14, wherein the light source disposed in the retaining device comprises an annular circuit board surrounding the top end of the light-permeable pipe, and a plurality of LEDs disposed on the annular circuit board.
